(19) United States
(12) Patent Application Publication
(10) Pub. No.: US 2020/0109542 A1
(43) Pub. Date: Apr. 9, 2020

(54) ELECTROMECHANICAL VALVE SYSTEM AND METHOD FOR SHOWER ASSEMBLY

(71) Applicants: NAGESH SIDDABASAPPA MAVINAHALLY, Granada Hills, CA (US); VINAYAKA SHANMUKHAPPA MAVINAHALLI, Shanivarasanthe (IN); Dhanush Mahesh Mavinahally, Hippali (IN)

(72) Inventors: Nagesh Siddabasappa Mavinahally, Granada Hills, CA (US); Vinayaka Shanmukappa Mavinahalli, Shanivarasanthe (IN); Dhanush Mahesh Mavinahally, Hippali (IN)

(21) Appl. No.: 16/355,708

(22) Filed: Mar. 16, 2019

Related U.S. Application Data
(60) Provisional application No. 62/743,728, filed on Oct. 10, 2018.
(60) Provisional application No. 62/751,550, filed on Oct. 27, 2018.
(60) Provisional application No. 62/742,277, filed on Oct. 6, 2018.
(60) Provisional application No. 62/735,055, filed on Sep. 22, 2018.

(51) Int. Cl. E03C 1/05; H04W 4/80; E03C 1/04; B05B 1/18

(52) U.S. Cl. CPC E03C 1/057; B05B 1/18; E03C 1/0408; H04W 4/80

(57) ABSTRACT

The invention includes a controller-mechanical assembly for a shower head and the electromechanical valve actuated by a contactless sensor in response to momentarily waving of the hand momentarily raised above the head of the user. The assembly for remotely controlling the flow of fluid in showers includes a contactless sensor to actuate at least one electromechanical valve to turn on and off the flow as desired by the user. The actuation logic includes stimuli such as motion or interruption of wireless signal by a raised hand. The valve assembly includes a manually operated bypass valve to override the electromechanical valve, in case the electrical system malfunctions or power supply is down. In another embodiment, the controller-mechanical assembly and the shower head are integrally made for compactness and both have a common wall between them and has water passage in the wall connecting each other.

### RELATED APPLICATIONS

The present application claims the benefit of priority of U.S. Provisional Patent application No. 62/742,277, filed Oct. 6, 2018, entitled “FOOT ACTUATED CONTACTLESS ELECTRONICALLY CONTROLLED VALVE SYSTEM”, Provisional Patent application No. 63/743,728, filed Oct. 10, 2018, titled “ELECTRONICALLY CONTROLLED VALVE SYSTEM TO REDUCE WATER CONSUMPTION”, Provisional Patent application No. 62/751,550, filed Oct. 27, 2018 titled “ELECTRONICALLY CONTROLLED VALVE SYSTEM TO REDUCE WATER CONSUMPTION”, and Provisional Patent application No. 62/735,055 filed Sep. 22, 2018 titled “FOOT ACTUATED ELECTRONIC FLOW CONTROL SYSTEM FOR FAUCET”

### FIELD OF INVENTION

The objective of the invention disclosed here is to save precious water when taking shower, improve hygiene, extend the life of the hardware, and enhance convenience to the user. According to the EPA study, showering is one of the leading ways we use water in the home, accounting for nearly 17 percent of residential indoor water use for the average family, that adds up to nearly 40 gallons per day. That's nearly 1.2 trillion gallons of water used in the United States annually just for showering, or enough to supply the water needs of New York and New Jersey for a year! It is believed by the inventor that by retrofitting the shower with a device disclosed here one can save a considerable amount of this water. The present invention relates to a device to control the valve, particularly for turning the shower water on or off by momentarily raising the hand above the head of the user and momentarily waving it in front of a contactless infrared sensor. Non-contact actuation of the valve improves hygiene and is convenient, secondly not turning on and off often increases the life of the valves. The controller-mechanical assembly includes housing for the internal parts, a power source such as a battery pack, an inlet and an outlet pipe fitting for receiving and discharging water with at least one electromechanically actuated valve between the inlet and the outlet to turn on and off the water based on the distance of the user from the sensor and vary the flow rate accordingly. The drawback with the proximity sensors and prior arts is that if the user wants to keep the water running and momentarily moves away from the sensor, the water is cut off or reduced without the user really desiring the change in flow. Secondly, the range of the sensor may not be suitable for children and shorter people. Kitchen faucets, however, have been in use for many years and there are many prior arts. The prior arts include contactless switches/sensors mounted on the faucet spout. Hand or any object waved in front of the sensor actuates the valve and have short comings in terms of placement for application in showers and the fittings. Many prior arts installed on the wall are normally for regulating the temperature of the water and to change the spray pattern or switch from one hand held shower head to fixed shower. In most cases, the water is turned off by a manual valve either by turning a knob or by pressing a button on the wall. The drawback is that it is inconvenient and unhygienic to touch the knob when the hand is either dirty or full of soap. When the hand has soap on it, it discourages people to turn off the water when it is not needed while taking the shower, and as a result water is wasted. Also, in some cases the cold water comes out first momentarily, immediately after the water is turned on. The water continues to run indefinitely until the user manually turns the handle to shut the water. The current invention provides a better solution in which the water can be stopped without touching any of the knob or button, merely by waving the hand above the head. Waving of hand above in front of the contactless sensor is a hand signal that actuates the sensor, which in turn sends a signal to the controller and the controller processes the signal and actuates the electromechanical valve to open or close depending on the instance. The first instance of the hand signal opens the valve and the second instance closes the valve. Some sensors require touching the housing to send signal to the controller, which in turn actuates the electromechanical valve. Such sensors are also known as capacitor sensor. The warm water is available immediately upon turning the valve on. The electromechanical valve that opens and closes the valve for water flow is mounted inside the shower head or within the close proximity of the shower head and therefore, there is no delay in warm water discharging through the spray holes and reaching the user. The advantage with the current invention is that the new invention can be adopted to any existing shower system and installed without the need for major changes to the plumbing or need of a qualified or technically trained professional plumber. The turning on and off of the valve in this disclosure is not dependent on the distance of the user from the sensor. The valve is actuated by the hand within a narrow range of the proximity of the sensor or by touching the surface of the shower head assembly.

The assembly receives the water from the mixer of hot and cold water or just cold water depending on the original water supply system. The water flows through the electromechanical valve assembly and to an outlet that is connected to a shower head. A pre-programmed electronic control unit turns on or off the water in response to stimulus, which is raising of the hand above the head and waving it in front of the sensor (hand signal) and it can automatically turn off the electromechanical valve after a pre-determined period of time (T), thus preventing wastage of water. The electromechanical valve is operated by a DC power supply, which can be either a set of batteries or directly connected to AC power adopter. The assembly includes a manual valve to bypass the electromechanical valve when it is in off position and when there is malfunction of the system, including power failure. The manual valve optionally with a suitable design, can also adjust the flow rate from low to high through the shower head either in manual mode or automatic mode. In a more complex system, there can be multiple solenoid valves to vary the flow rate or change spray pattern in the shower head or a single valve to regulate the flow rate. The sensor can be an Infrared sensor, motion sensor, proximity sensor, optical sensor, or a capacitor, but the preferred sensor in this embodiment is the Infrared sensor. Therefore, the embodiment is better for the environment and saves precious water from being wasted and it saves money and reduces carbon foot print in the form of reduced amount of energy required to pump less amount of water. It is roughly estimated that the embodiment disclosed when used efficiently reduces water approximately 10% or more.

### BRIEF DESCRIPTION OF DRAWINGS

FIG. 1 is a schematic of the electro-mechanical assembly 510.

FIG. 2 shows the flow chart for the controller actuating the electromechanical valve.

FIG. 3 shows different views of the embodiment 500 having shower head with multiple water spray holes and the controller-mechanical assembly 510.

FIG. 4 shows handheld shower head with a flexible hose attached to the controller-mechanical assembly.

FIG. 5 shows multiple views of the controller-mechanical assembly 510 having a sensor on the sensor collar attached to the outlet pipe and FIG. 5(e) shows embodiment with the sensor 162 on the housing

FIG. 6 shows the embodiment 550, the shower head integral with the controller-mechanical assembly. FIG. 30(a) is the perspective view, (b) is top view, and (c) is the side view of 550.

FIG. 7 shows the embodiment 580, the shower head integral with the controller-mechanical assembly having a female collar 524 inside the cavity 511. FIG. 32(a) is a perspective view of 580 without the top cover, (b) is another perspective view, (c) is top view of 580 without the top cover, and (d) and (e) show sectional views two versions of the embodiment 580.

FIG. 8 is a sectional view of the FIG. 7 having the top cover 537.

FIG. 9 shows perspective of the electro-mechanical assembly with a hook for the handheld shower head.

FIG. 10 shows perspective of the electro-mechanical assembly with a magnet on the bottom face to attach a handheld shower head.

FIG. 11 shows exploded view of a two-piece assembly of the embodiment 580, having the female collar 524 integral with the controller-mechanical assembly 510

FIG. 12 shows another perspective view of FIG. 11.

FIG. 13 shows exploded view a two-piece assembly of the embodiment 580 with female collar 524 integral with the shower head 522.

FIG. 14 shows perspective view of the embodiment 600 having dual showerheads; an outer fixed showerhead and a handheld showerhead at the center.

FIG. 15 shows embodiment 600 with the handheld showerhead detached from the base.

### DETAILED DESCRIPTION

With reference to the prior arts for the contactless faucets, the sensors are mounted on the spout of the faucet, above the sink and actuated by the touch or motion of a hand or any object on front the sensor. The sensors are located below the water outlet in the spout and the spout is attached to the sink. The control valve and the controller are farther away from the spout and are under the sink.

For the purpose of understanding the elements, the controller-mechanical assembly 510 has a housing 512 having an open top and a closed bottom with the side walls. It is possible to have housing split along a plane parallel to the inlet and outlet pipe for the purpose of assembling the parts. Appropriate water passages are provided within the housing, by means of a sub-assembly to which the electromechanical valve is attached. The top opening is closed with a top cover and the top cover may form upper half of the housing for ease of assembling the parts inside the cavity 511 of the housing 512. The shower head 522 is a housing having an open bottom and a top wall having water inlet passages as needed. The bottom opening of the shower head has a cover 542 with many spray holes and is rigidly attached to the shower head 522. Internal parts of the shower head are similar to any standard and commercially available shower heads. The two housings of the controller-mechanical assembly and the shower head are made as one piece/body in an integrally made part (housing) with a common wall 536b between the controller-mechanical housing 512 and the shower head housing 522. The two housings can also be made as two separate pieces and joined appropriately at the bottom of the controller-mechanical housing to form an integral assembly. The term integral means either the controller-mechanical housing 510 and the shower head housing 522 made as one piece or made as two separate pieces and attached to each other. From the assembling point of view, the electromechanical valve, female inlet collar and the male pipe outlet may be a subassembly inserted into the controller-mechanical housing. The inlet, mounting for the electromechanical valve, and the outlet may be one molded piece.

The embodiments described here having an electronic controller (controller), an electromechanical valve, a manual valve with a lever, a battery box or a cavity and sensors and all of the above elements mounted above the water outlet in the showerhead. The electronic controller is a controller having electronic components commonly known as brain or

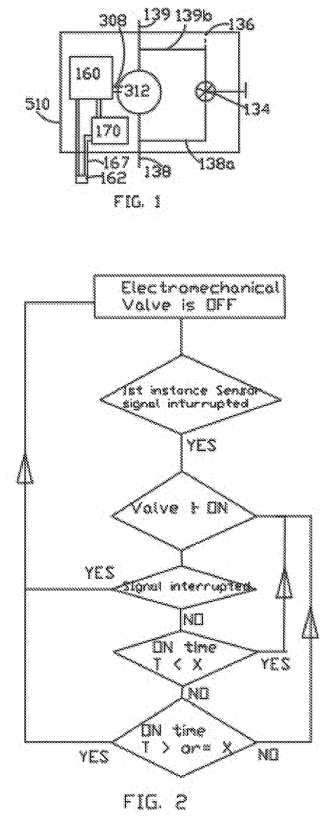

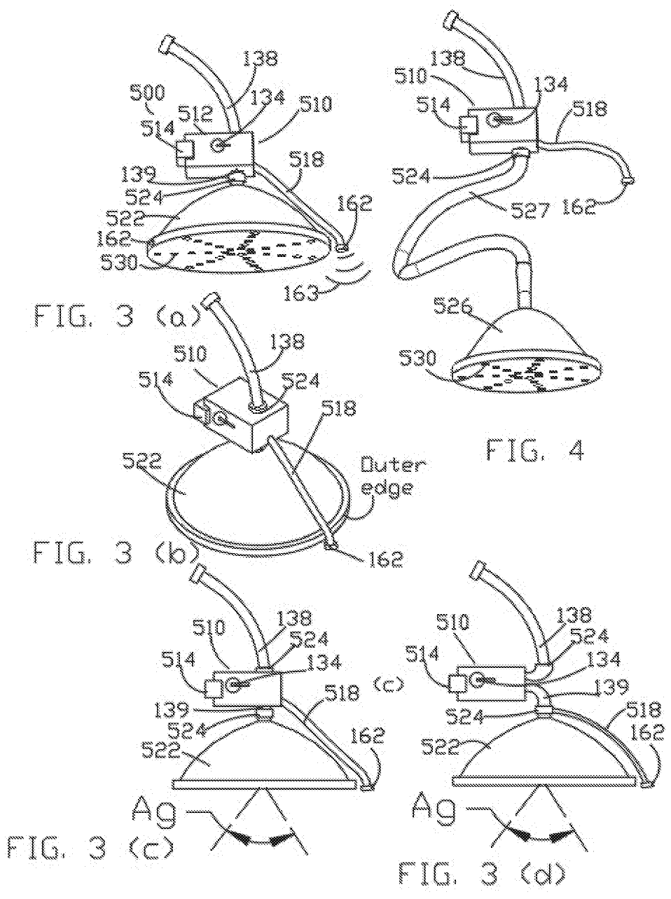

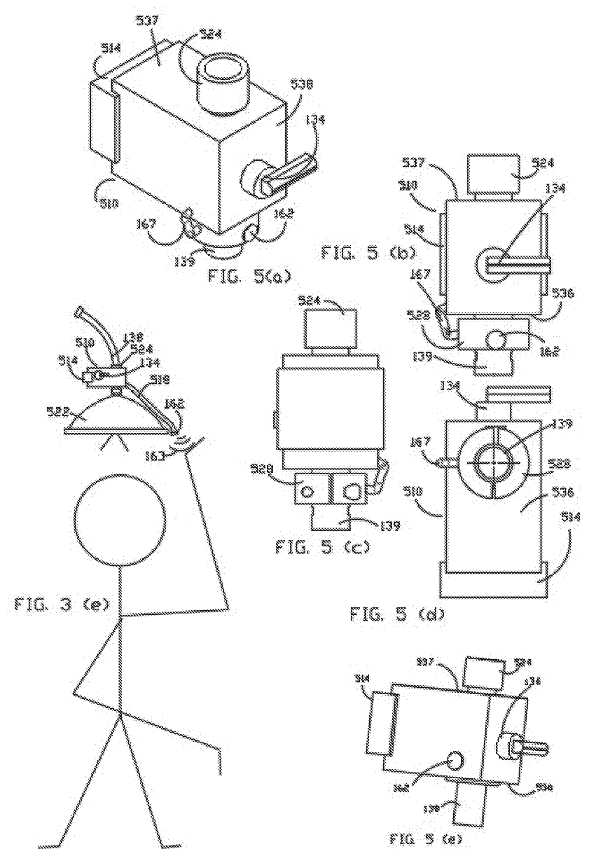

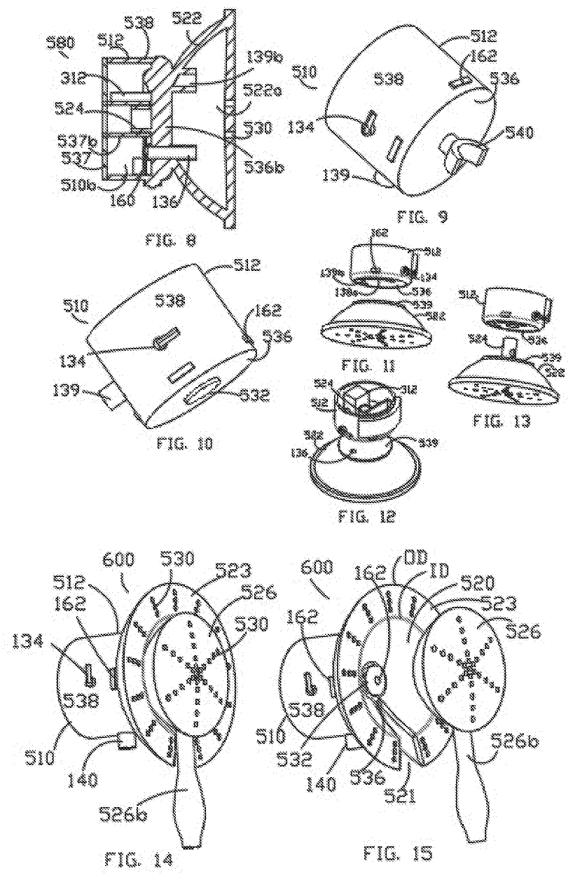

The elements of different embodiments disclosed here are common between the embodiments shown in FIG. 3 through FIG. 15 and a schematic of the controller 160, electromechanical valve 312, wire harness and sensor 162 shown in FIG. 1. The controller-mechanical assembly 510 is attached to a shower arm (inlet) 138 through a threaded female collar 524 preferably having ½ inch NPT thread and the said female collar is integral to the assembly 510 and is attached to a shower head 522 at the bottom through a male pipe fitting (outlet) 139 preferably having ½ inch NPT thread, where in the threaded male pipe is also integral to the assembly 510. Suitable adopters may be used to attach the embodiments to differently sized arm and showerheads. FIG. 3 shows perspective views and a side view of the embodiment 500 immovably attached to a shower head 522 at the bottom and the top is attached to the arm 138. is similar to FIG. 3, but has a flexible hose 527 attached to a handheld shower head 526. Ordinarily skilled people can understand the fittings and shower head assembly explained with the Figures. The embodiment 500 in plurality consists of a controller-mechanical assembly 510 having a housing 512, a cavity 510a/511 inside the housing shown in FIG. 7, an electromechanical valve 312, an electronic controller 160, at least one contactless sensor 162, an optional manual bypass valve 134 having a handle/lever, a container 514 for batteries, a female threaded pipe collar 524, and a male threaded pipe 139 (outlet), and a top cover 537 (not shown). The battery box 514 may be integral with the assembly 510 or may be outside the housing 512, but attached to the housing. The controller-mechanical assembly 510 has a female threaded collar 524 to receive water from the arm 138 which is connected to a water supply pipe and an outlet 139 having a male thread that is attachable to any shower head 522, as shown in FIG. 3. The arm 138 is generally attached at the wall to the water supply line. The inlet female collar 524 and the outlet male threaded pipe 139 are aligned to be in-line with each other for ergonamical reasons and the electromechanical valve 312 is between the inlet female collar and the male pipe outlet. However, inlet and the outlet can be off-set, but preferably parallel. The embodiment 500 has a contactless sensor 162 attached to one end of a stiffer but flexible sensor tube (cable) 518 that extends away from the housing and the other end of the tube (cable) 518 is rigidly attached to the housing 512, as shown in FIG. 3 and FIG. 34. The stiffer, but flexible sensor tube (cable) 518 allows for adjusting the sensor to any position by the user without need for clamping the cable or the sensor to any rigid body and it stays in any set position. The sensor tube (cable) 518 extends at least up to the outer edge of the shower head 522, as shown in the FIG. 3 FIG. 27. A longer sensor tube (cable) 518 may be used to position the sensor at any suitable location around the shower head 522, including below the shower head to help user who cannot stretch the hand to the sensor, and the excess length may be wound round the outlet 139 or the arm 138. FIG. 5(a) through (d) show different views of the controller-mechanical assembly 510 where the sensor 162 is on a rotatable sensor collar (ring) or a clamp 528 attached to the male threaded pipe outlet 139. Alternatively, the sensor 162 may be integral with the controller-mechanical assembly 510 or shower head either at the center or preferably at the fixed outer edge or the rim and away from the water spray.

The contactless sensor 162, for example an IR (Infrared) sensor or a motion sensor, processes the interruption of the wireless signal 163 in response to stimuli and sends signal to the electronic controller 160 through the wire harness 167 or wirelessly through blue tooth transmitter for further processing and execution/actuation of the electromechanical valve 312 (to turn water flow on or off) through the wire harness 308. Interruption of the signal in the case of the Infrared sensor is means that the sensor senses an object in front of the sensor, a hand in this case. The hand, in this embodiment, has to be within a range of 12 inches or less from the sensor. The stimuli in this case is raising the hand over head and waving of hand in front of the sensor, which is termed as hand signal, as shown in FIG. 3(e) and the response for the first instance of interruption in signal (hand signal) is to turn on the electromechanical valve 312 and to turn it off at the second instance of the stimuli (hand signal), if the second instance of the stimuli occurs when the time T is less than time x or turned off when T is equal to x. Time T is the length of time the valve is on and x is the maximum predetermined time the valve remains open. X is a parameter stored in the controller 160 and is optionally adjustable by the user. The electronic controller unit 160 processes the input parameters received from at least one sensor and compares it with the pre-determined parameters, as shown in the flow charts FIG. 2 and sends signal to actuate at least one electromechanical valve 312 for a pre-determined length of time x. The purpose of keeping the electromechanical valve 312 open only for a pre-determined period of time x (like 60 to 120 seconds) at a time is to prevent wasting water if the valve is actuated to open position for other reasons than human interaction as well as to automatically turn off in case the user forgets to turn off the valve. Secondly it also reminds the user that shutting water more often than not helps conserve the water. When the valve is automatically shut closed after a pre-determined time x or in response to stimuli, the time T is set to zero, the valve is opened again by waving the hand and time T starts ticking. Each time the electromechanical valve is closed either by the stimuli or when the time T is equal to x, or due to external wireless signal, the next stimuli (signal interruption/hand signal) will be the first instance of stimuli. The sensor 162 is preferred to be facing sideways (not downward) to prevent unintentional stimulus by a very tall user or merely due to raising of the hand closer to the spray holes.

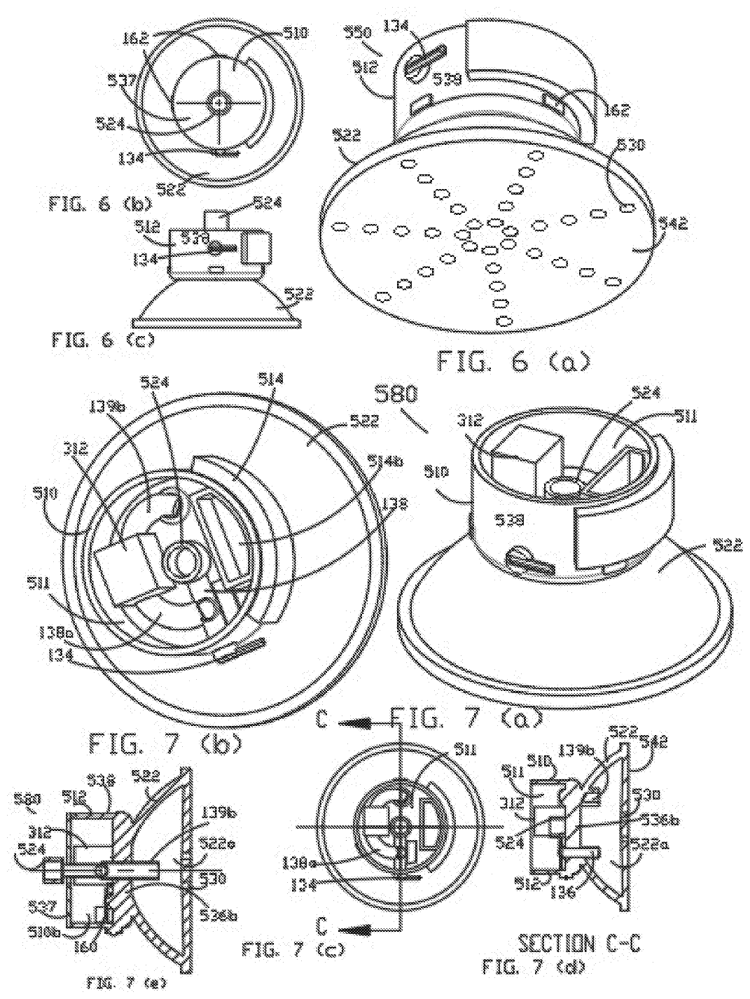

Prior to this event, the user would have turned on the cold and hot water knobs or valves, normally fitted on the wall or a water supply pipeline. The first instance occurs when time T is zero or a period of more than a preset time. The electromechanical valve by default will be in closed position. The water received from the arm 138 flows out through the electromechanical valve 312 and through the outlet 139. The water from the controller-mechanical assembly 510 either flows into the attached shower head 522 through a female collar 524 in the showerhead as in embodiment 500 shown in FIG. 3 or directly into the cavity 522a of the shower head 522 as in embodiments 550, 580, and 600 shown in FIG. 6, FIG. 7 and FIG. 15. The optional manual valve 134 is in parallel circuit of water line, inside the controller-mechanical assembly 510, leading from inlet 138 to the outlet 139 as shown in the schematic in FIG. 1. In the open position of the manual valve 134, the water circuit bypasses the electromechanical valve 312 and allows the water to flow directly from inlet 138 to the outlet 139 or into the cavity 522a, as the case may be. Alternative to turning the handle of the manual valve 134, it is possible to have a push/pull type valve to open and shut the manual valve. The manual valve 134 may be designed to set the flow into the electromechanical valve 312 at high or low flow rates as well. The handle/lever of the manual valve 134 is outside the housing 512 and operable by the user to set the position to manually bypass the electromechanical valve 312 and also to set the flow to low or high rates in automatic or manual modes. Automatic mode is when the flow is turned off or on by the electromechanical valve in response to the stimuli and the manual mode is when the flow is turned on or off manually by the manual valve when it is in bypass position. If a single manual valve is regulating the flow rate into the electromechanical valve as well as the bypass circuit, then the water flow circuit may consist of parallel and in-series water flow circuits, not shown here.

The embodiment 550 shown FIG. 6 and FIG. 7 has the controller-mechanical assembly 510 integral with the shower head 522. Integral means the housing 512 of controller-mechanical assembly 510 and the showerhead are molded as one piece or become one piece or one body after rigidly attaching the controller-mechanical assembly 510 to the shower head 522 such that the bottom face 536 of the assembly 510 and top face of 539 the shower head 522 are joined together and form a jointed wall between the two housings. Alternatively, the housing 512 of the electro-mechanical assembly 510 and upper body 522b of the showerhead 522 are molded together as one piece and have a common wall 536b between the two bodies. It must be noted that the bottom side of the shower head 522 has a separate lower body 522c having multiple spray holes and the lower body 522c can be made of multiple pieces, including made of ceramic or metal material having colored designs on the bottom face 542. The internal water passages may be molded or form a passage when the two bodies are joined together. The inside of the shower head is not shown, but can have additional components and multiple cavities to obtain different spray patterns, as in any commercially available shower heads. The inlet female collar 524, electromechanical valve 312, and the outlet 139 from the electromechanical valve 312 can be a subassembly and installed on to the housing 512 or the integral housing of the two bodies 512 and 522b. FIG. 6(a) shows the perspective view of the embodiment 550 consisting of the controller-mechanical assembly 510 in the upper section of the assembly and having a female threaded coupler 524 protruding outside the housing 512, a mechanical by pass valve 134, at least one sensor 162, preferably 2 or more sensors 162 angularly spaced on the circumferential surface 538 of the housing 512, as shown in FIG. 6(a) through (c). The shower head 522 has more than one spray hole 530 on the bottom face 542 of the assembly. The spray pattern from the showerhead may be variable as in many commercially available shower heads. For example, the showerhead can have a rotatable rim that varies the protrusion of the bottom face 542 to change spray patterns. The bottom part of the shower head can be made of multiple pieces and spray hole sizes and angles to alter the spray pattern by rotating or sliding a knob the on the bottom face 542. The controller-mechanical assembly 510 shown in FIG. 6 is cylindrical in shape for ergonomical reasons and preferably concentric to the shower head 522. However, the controller-mechanical assembly may be of any other shape, as shown in FIG. 4 and FIG. 5. The centerline CL of the controller-mechanical assembly 510 is in line with the centerline of the shower head 522 as shown in FIG. transmitter, before getting under the shower head. In the case of wireless signal received from the remote device, the electronic control unit 160 has a built-in wireless receiver.

The controller-mechanical assembly 510 may also have dual outlets in which first outlet 139 is for the fixed showerhead 522 and the second outlet 140 is for the handheld shower head 526, with an optional manual valve or a second electromechanical valve to choose water into either fixed head 522 or the handheld shower head 526. First sensor actuates the first electromechanical valve and the second sensor actuates the second electromechanical valve. Shutting off water to either one of the shower heads will be due to a second instance of the stimulus (hand signal).

FIG. 14 and FIG. 15 show embodiment 600 having dual shower heads; a fixed showerhead 523 and a handheld shower head 526. In the embodiment 600, the fixed shower head 523 is integral with the controller-mechanical assembly 510. The fixed showerhead 523 has a showerhead recess 520 at the center to accept the handheld shower head 526. The fixed showerhead 523 has a cutout 521 at the lower region to accommodate the handle 526b of the handheld shower head 526, as shown in FIG. 15. It must be noted that a cutout 521 is an option. The fixed shower head 523 has front face with multiple spray holes 530, and the bottom face 542 has an outer diameter OD and an inner diameter ID in the case of embodiment 600. In FIG. 14, the handheld shower head 526 is attached to the magnetic base 532 at the bottom of the recess 520. FIG. 15 shows the handheld showerhead 526 detached from the base. The shape and size of the concave recess 520 extending from the ID to the magnetic base on the bottom face 536 of the controller-mechanical housing 512 is more or less matches the shape and size of the back housing of the handheld showerhead 526. The handheld shower head 526 is connected to the male threaded outlet pipe 140 through a flexible hose 527. The male threaded outlet pipe 140 is on the exterior surface of the housing 512. Alternative location for the male pipe may be provided, for example on the side face of the fixed ring shower head 523. The water flow to the handheld showerhead can be turned on and off by the sensor 162 (switch) at the center of the magnetic base 532 as shown or on the inner surface of the recess 520. The sensor 162 may also be a plunger, in this instance, that activates and deactivates the second electromechanical valve inside the controller-mechanical assembly 510. The contactless sensor 162 may also be placed on the bottom face 542 or curved inner surface of the recess 520 of the fixed showerhead 523 and tab (not shown) on the handheld showerhead can stimulate or actuate the sensor. The sensor may be placed at other convenient place on the assembly, but actuated by the handheld showerhead 526. When the handheld showerhead 526 is attached (or placed inside the fixed showerhead) to the magnetic base 532, the flow is cut off automatically to the handheld shower head 526 and only the fixed showerhead 523 will spray the water. The water through the fixed head is turned on or off by waving the hand in front of the first sensor 162. The water through the fixed showerhead 523 is turned off when the handheld shower head 526 is removed or detached from the magnetic base. However, the flow into one or the other shower head or into both the showerheads can be programmed to turn on or off as desired depending which sensor is stimulated. The controller-mechanical assembly 510 has at least one contactless sensor 162 and hand waving in front of the sensor is the stimulus. By default, water flows only through the fixed showerhead 523 when the handheld showerhead 526 is attached to the magnetic base. A second sensor 162 on the housing 538 may be provided to turn on and off flow through the handheld showerhead 526 even when the handheld showerhead is attached to the magnetic base. It may be desirable to have water through only one head at a time to save water and the maximum flow rate is desirable to be 2.0 to 2.5 gallons per minute or less.

Alternative to having a magnetic base 532 at the center of the fixed showerhead 523, it is possible to have a magnetic ring around the fixed showerhead and the handheld shower head is a ring like head having a metal attractable to the magnet as similar showerheads without the controller-mechanical assembly is available today. Also, the recess may have a suitable receptor such as a hook or a bracket to receive the handheld shower head. Prior arts having dual head have mechanical lever or switch to divert the flow into one or the other head, which can malfunction over time due to build-up of minerals in the water. Therefore, contactless sensors and the electromechanical valves are more desirable.

The manual bypass valve 134 may be set to either shut off, low or high flow positions. It is also possible to turn on the electromechanical valve by using a Bluetooth signal from a remote controller, such that the cold water runs first and after a predetermined period of time of y seconds or temperature t degrees F. is reached in the shower head it automatically shuts off until the user turns the valve on by waving the hand in front of the sensor 162. It is also possible to turn on the shower head remotely at a predetermined time of the day through the internet or Bluetooth applications. In such systems, cold water may run continuously, initially, until a predetermined temperature is reached at the electromechanical valve and then the system closes the valve to periodically open for a short period to maintain the water temperature for up to a predetermined time and automatically shut off once that time is reached. The periodical opening and closing are over ridden by the first instance of hand signal, at which time the time T starts from zero.

In order to make the showerheads more efficient, showerheads having flow rate no more than 2.0 gallons per minute, at an inlet pressure range of 20 to 81 PSI, may be integrated with the controller-mechanical assembly. Optimized flow rate is achieved by the optimized number of spray holes, spray hole sizes and the spray pattern, and the spray angle. The electromechanical valve can be made to pulsate at a pre-determined frequency. Pulsation of the electromechanical valve momentarily lowers or shuts off the water flow, thus reducing the total water flow during showering. A dampening chamber and elements are built into the showerhead assembly, in a special case to mitigate the shockwave otherwise traversing the upstream pipeline.

The electronic controller (controller) unit 160 is programmable to keep the valve open for a predetermined period of x seconds once the valve is triggered to open by the hand signal and may have a clock to log the usage and interface wirelessly with an external electronic device, such as a phone or computer or store on the internet or a Bluetooth transmitter. The usage may be in number minutes or volume of water used in a fixed period of time. There may be red and green LED lights near the sensor or on the assembly 510 to visually indicate that the electromechanical valve is off or on.

The objective of the embodiment is to turn on and off the water as desired by the user by waving the hand above the head level as shown in FIG. 3(d).

The sensor 162 is not limited to Infrared, light emitting, motion sensing, or proximity sensors. The preferred sensor in the embodiment disclosed here is the close-range infrared sensor, whose range is up to about 6 inches, unlike the proximity sensor of prior arts. It must be noted that, having a manual valve in the controller-mechanical assembly 510 is an optional feature. Embodiments may be constructed without the manual valve. Optionally manual valve may be in the shower head assembly by way of appropriate water passages to bypass the electromechanical valve. Additional manual valve may be provided in the shower head as is available in many shower heads to change the spray pattern at the out let of the shower head.

1. An automatic valve system for a shower assembly comprising:
a controller-mechanical assembly having a housing, at least one electromechanical valve, an electronic controller, a bypass manual valve, and the said manual valve having its handle/lever outside the exterior wall, an electric power source, an inlet collar for attachable to the arm on the bathroom wall, a threaded male pipe outlet attachable to a showerhead, at least one flexible sensor tube having at least one contactless sensor at one movable end of the sensor tube and the other end of the sensor tube rigidly attached to the controller-mechanical assembly, the contactless sensor is stimulated by raising and waving a hand over the head of the user, electromechanical valve is turned on by the first instance of the stimulus, and electromechanical valve is turned off either by the second instance of the stimulus or when time T is equal to x, whichever occurs first.

2. An automatic valve system for a shower assembly comprising:
a controller-mechanical assembly, a controller-mechanical assembly having a housing, at least one electromechanical valve, an electronic controller, a bypass manual valve, an electric power source, a female inlet collar, a shower head integral with the controller-mechanical assembly at the bottom of the controller-mechanical housing, at least 2 spray holes on bottom face of the said shower head assembly, at least one sensor, a common wall between the controller-mechanical assembly and the shower head, at least one water outlet passage in the controller-mechanical assembly connecting to at least one cavity in the shower head, a water passage connecting the manual valve to at least one cavity in the shower head, electromechanical valve is turned on by the first instance of the stimulus, and electromechanical valve is turned off either by the second instance of the stimulus or when T is equal to x, whichever occurs first.

3. An automatic valve system for a shower assembly comprising:
a controller-mechanical assembly having a housing, at least one electromechanical valve, an electronic controller, a bypass manual valve, and the said manual valve having its handle/lever outside the exterior wall of the housing, an electric power source, a threaded female inlet collar, a threaded male outlet, at least one sensor, the inlet collar and the male outlet respectively attachable to the outlet pipe (known as arm) on the wall and the shower head, the sensor is stimulated by waving a hand above the head level, electromechanical valve is turned on by the first instance of the stimulus, and electromechanical valve is turned off either by the second instance of the stimulus or when T is equal to x, whichever occurs first.

4. An automatic valve system for a shower assembly comprising:
a controller-mechanical assembly having a housing, a first electromechanical valve for controlling flow to the fixed shower head, a second electromechanical valve for controlling flow to the handheld shower head, an electronic controller, an optional bypass manual valve, said manual valve having its handle/lever outside the exterior wall, an electric power source, an inlet collar, an outlet to the handheld shower head, the fixed shower head integral with the controller-mechanical housing, a water passage from controller-mechanical assembly to at least one cavity in the fixed shower head, fixed shower head having a recess, a detachable handheld shower head, a first sensor for actuating the first electromechanical valve, a second sensor for actuating a second electromechanical valve for the handheld shower head, and first sensor and the second sensor on the fixed shower.

5. An automatic valve system for a shower assembly of claim 2 or claim 4 wherein the shower head has a bottom face with at least two spray holes connected to at least one cavity in the said shower head.

6. The automatic shower head assembly of claim 25 wherein the cavity is a divided cavity and each cavity is connected to different sets of spray holes, and different sets of spray holes have different spray patterns.

7. Spray patterns of claim 6 wherein spray patterns are user selectable.

8. The automatic shower head assembly of claim 1 or claim 2 or claim 3 or claim 4 wherein at least one stimulus is a wireless signal from a remote device.

9. The remote device of claim 8 wherein remote device is a smart phone.

10. The remote device of claim 8 wherein remote device is a WiFi transmitter.

11. The automatic valve system for a shower assembly of claim 1 where in sensor is attached to the outlet pipe of the controller-mechanical assembly.

12. The automatic valve system for a shower assembly of claim 1 or claim 2 or claim 3 or claim 4 wherein at least one sensor is an infrared sensor.

13. An automatic valve system for a shower assembly of claim 1 or claim 2 or claim 3 or claim 4 wherein at least one sensor is on the housing of the controller-mechanical.

14. The automatic valve system for a shower assembly of claim 1 or claim 2 or claim 3 or claim 4 wherein at least one sensor is on the shower head.

15. The automatic valve system for a shower assembly of claim 3 wherein at least one sensor is on a rotatable collar attached to the outlet pipe.

16. The automatic valve system for a shower assembly of claim 1 or claim 2 or claim 3 or claim 4 wherein the first electromechanical valve is for a fixed shower head, a second electromechanical valve is for a handheld shower head and the first sensor is for actuating the first electromechanical valve and the second sensor is for actuating the second electromechanical valve.

17. The automatic valve system for a shower assembly of claim or claim 2 or claim 3 has a hook on the exterior side of the controller-mechanical housing.

18. The automatic valve system for a shower assembly of claim or claim 2 or claim 3 wherein has a magnet on the controller-mechanical housing to detachably receive a handheld shower head and the said handheld shower head has a metal attachable to the said magnet.

19. The automatic valve system for a shower assembly of claim 4 wherein the recess magnetic base for receiving a detachable handheld shower head, said magnetic base is at the bottom of the recess, said detachable handheld shower head having on the back cover a metal attachable to the magnet, said sensor at the bottom of the recess, and said sensor stimulated by attaching and detaching the handheld shower head.

20. The automatic valve system for a shower assembly of claim 4 wherein the electromechanical valves are actuated by waving a hand in front of the said first sensor for the first electromechanical valve, the second electromechanical valve is actuated by attaching or detaching the said handheld shower head, the first electromechanical valve is turned on by the first instance of the stimulus, first electromechanical valve is turned off either by the second instance of the stimulus or when time T is equal to x or when the handheld shower head is detached from the fixed shower head, whichever occurs first, and the second electromechanical valve is turned off either by the second instance of the stimulus or when time T is equal to x or when the handheld shower head is attached to the base, whichever occurs first.

21. The automatic valve system for a shower assembly of claim 4 wherein at least one sensor is a capacitor type sensor.

22. The automatic valve system for a shower assembly of claim 1 or claim 2 or claim 3 or claim 4 wherein the controller has a built-in wireless receiver receiving stimulus from a remote device of claim 8.

23. The stimulus from a remote device of claim 23 wherein stimulus is generated by pressing a button on the remote device.

24. The remote device of claim 8 wherein remote device is a Bluetooth transmitter having at least one infrared sensor.

25. The automatic valve system for a shower assembly of claim 1 or claim 2 or claim 3 or claim 4 wherein at least one sensor is a motion sensor having a range of 12 inches or less.

26. An automatic valve system for a shower assembly comprising:
a controller-mechanical assembly having a housing, at least one electromechanical valve, an electronic controller, an electric power source, a threaded female inlet collar, a threaded male outlet, at least one sensor, the inlet collar and the male outlet respectively attachable to the outlet pipe on the wall and the shower head, the sensor is stimulated by waving a hand above the head level, a speaker integral to the shower head assembly, electromechanical valve is turned on by the first instance of the stimulus, electromechanical valve is turned off either by the second instance of the stimulus or when T is equal to x, whichever occurs first, and the speaker beeps when the time T is equal to x minus b.

27. An automatic valve system for a shower assembly comprising:
a controller-mechanical assembly, a controller-mechanical assembly having a housing, at least one electromechanical valve, an electronic controller, an electric power source, a female inlet collar, a shower head integral with the controller-mechanical assembly at the bottom of the controller-mechanical housing, at least 2 spray holes on bottom face of the said shower head assembly, at least one sensor, a speaker integral to the shower head assembly, a common wall between the controller-mechanical assembly and the shower head, at least one water outlet passage in the controller-mechanical assembly connecting to at least one cavity in the shower head, electromechanical valve is turned on by the first instance of the stimulus, electromechanical valve is turned off either by the second instance of the stimulus or when T is equal to x, whichever occurs first, and the speaker beeps when the time T is equal to x minus b.
